(19) United States
(12) Patent Application Publication
(10) Pub. No.: US 2008/0146082 A1
(43) Pub. Date: Jun. 19, 2008

(54) Filter

(75) Inventors: Han-Wei Lin, Taoyuan Hsien (TW); Chia-Hsin Lin, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/987,988

(22) Filed: Dec. 6, 2007

(30) Foreign Application Priority Data
Dec. 8, 2006 (TW) 95221684

(51) Int. Cl. H01R 13/66

(52) U.S. Cl. 439/620.09

(57) ABSTRACT

A filter includes a first housing having a first signal input terminal and a first signal output terminal, and a second housing having a second signal input terminal and a second signal output terminal. The second housing is stacked on and against the first housing.

### BACKGROUND OF THE INVENTION

1. Field of the Invention

The invention relates to an Internet device and more particularly to a filter and configuration thereof.

2. Description of the Related Art

With the progress of communication technology, information can be rapidly accessed over a high speed Internet connection via wired or wireless devices. Most current Internet devices are scaled down to meet micro-miniature requirements.

In FIG. 1, a conventional Internet device includes a plurality of filters 11, a circuit board 12 and a signal connector 13. The filters 11 are individually disposed on the circuit board 12. Information or signals received by the signal connector 13 are transmitted to the filters 11 via the circuit board 12 for performing signal processing, and the processed signal is transmitted to a system (not shown).

When the size of the circuit board 12 is reduced, the circuit board 12 cannot provide enough space for the dispersed filters 11 thereon.

### BRIEF SUMMARY OF THE INVENTION

The invention provides a filter and configuration thereof. An embodiment of an Internet device includes a circuit, a filter disposed on the circuit, and a signal connector connected to the circuit. The filter includes a first housing having a first signal input terminal and a first signal output terminal and a second housing having a second signal input terminal and a second signal output terminal. The second housing is stacked on and against the first housing. The signal connector disposed on the circuit is electrically connected to the circuit. The stacked first and second housings can be integrally formed. The first housing is connected to the circuit via the first signal input terminal and the first signal output terminal, and the second housing is connected to the circuit via the second signal input terminal and the second signal output terminal. The circuit is electrically connected to the signal connector to receive external Internet information or signals.

The Internet device of the invention is a micro-miniature electronic device which includes a stacked filter disposed on the circuit for minimizing dimensions thereof and reducing the manufacturing cost.

Further scope of the applicability of the present invention will be apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the subsequent detailed description and the accompanying drawings, which are given by way of illustration only, and thus are not limitive of the present invention, and wherein:

FIG. 1 is a schematic view of a conventional Internet device;

FIG. 2 is a schematic view of an Internet device of an embodiment of the invention;

FIG. 3 is a perspective view of a filter of FIG. 2; and

FIG. 4 is an elevated front view of the filter of FIG. 3.

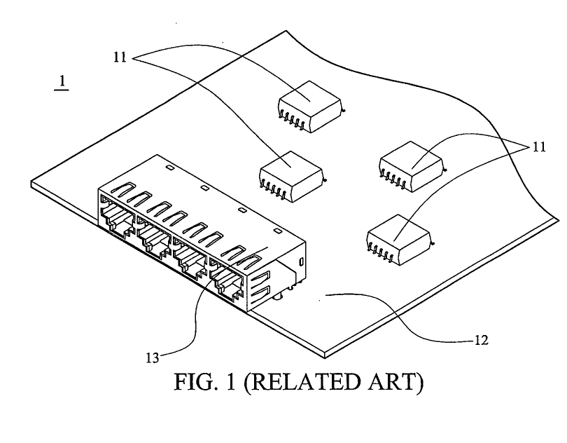

### DETAILED DESCRIPTION OF THE INVENTION

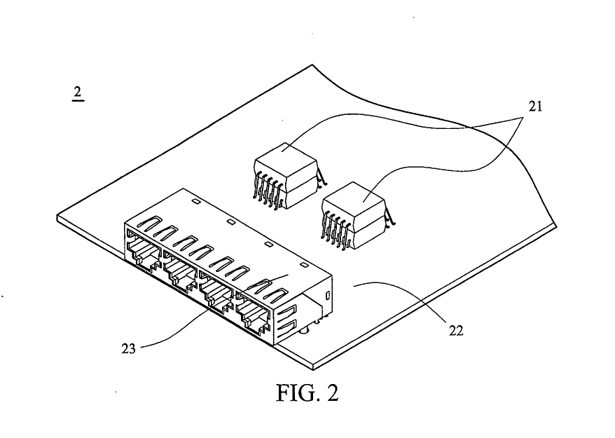

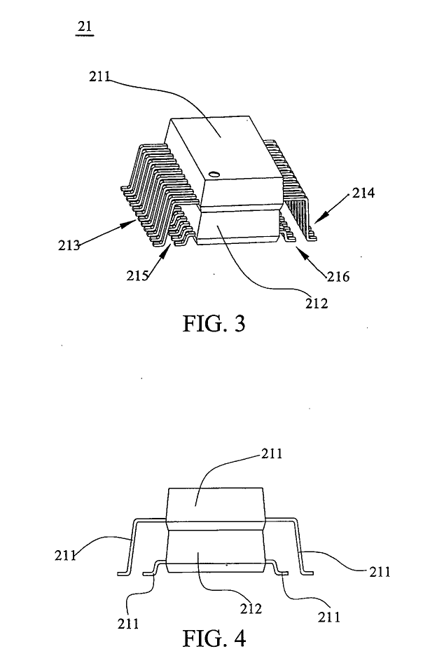

As shown in FIG. 2, an Internet device 2 of an embodiment of the present invention includes a filter 21, a circuit 22 having lines (not shown in FIGS.), and a signal connector 23, wherein the filter 21 and the signal connector 23 are disposed on the circuit 22. FIG. 3 is a perspective view of the filter 21, and FIG. 4 is a front elevated view of the filter 21. In this embodiment, the circuit 22 is a circuit board, and the signal connector 23 can be RJ-11, RJ-12 or RJ-45 connector.

Referring FIGS. 3 and 4, the filter 21 includes a first housing 211 having a first signal input terminal 213 and a first signal output terminal 214, and a second housing 212 having a second signal input terminal 215 and a second signal output terminal 216. The second housing 212 is stacked on and against the first housing 211.

The stacked first and second housings 211, 212 are formed as a single piece of plastic or other insulating materials. The first signal input terminal 213 and the first signal output terminal 214 are disposed on two sides of the first housing 211, respectively. The second signal input terminal 215 and the second signal output terminal 216 are disposed on two sides of the second housing 212, respectively.

The filter 21 disposed on the circuit 22 is electrically connected to the circuit 22 via the first signal input terminal 213, the first signal output terminal 214, the second signal input terminal 215 and the second signal output terminal 216. The signal connector 23 disposed on the circuit 22 receives external Internet information or signals.

When the signal received by the signal connector 23 is transmitted to the circuit 22, the signal is then transmitted to the filter 21 from the first signal input terminal 213 and the second signal input terminal 215 for performing signal processing. The processed signal is transmitted to the circuit 22 from the first signal output terminal 214 and the second signal output terminal 216. Finally, the filtered signal is transmitted to a system (not shown in FIGS.) via the lines of the circuit 22.

With respect to the related arts, it is understood that the Internet device of the embodiment is a micro-miniature electronic device, providing a stacking filter to minimize device dimensions and reduce manufacturing cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A filter comprising:
a first housing having a first signal input terminal and a first signal output terminal; and
a second housing having a second signal input terminal and a second signal output terminal;
wherein the second housing is stacked on the first housing.

2. The filter as claimed in claim 1, wherein the stacked first and second housings are formed as a single piece.

3. The filter as claimed in claim 1, wherein the first and second housings are made of plastic or an insulating material.

4. The filter as claimed in claim 1, wherein the first signal input terminal and the second signal input terminal receive an Internet information.

5. The filter as claimed in claim 1, wherein the first signal output terminal and the second signal output terminal output an Internet information.

6. The filter as claimed in claim 1, wherein the first signal input terminal and the first signal output terminal are disposed on two sides of the first housing, respectively.

7. The filter as claimed in claim 1, wherein the second signal input terminal and the second signal output terminal are disposed on two sides of the second housing, respectively.

8. An Internet device comprising:
a circuit;
a filter disposed on the circuit and comprising:
a first housing having a first signal input terminal and a first signal output terminal; and
a second housing having a second signal input terminal and a second signal output terminal, and stacked on the first housing; and
a signal connector disposed on the circuit and electrically connected to the circuit.

9. The Internet device as claimed in claim 8, wherein the connected first and second housings are formed as a single piece.

10. The Internet device as claimed in claim 8, wherein the first and second housings are made of plastic or an insulating material.

11. The Internet device as claimed in claim 8, wherein the first signal input terminal and the second signal input terminal receive an Internet information.

12. The Internet device as claimed in claim 8, wherein the first signal output terminal and the second signal output terminal output an Internet information.

13. The Internet device as claimed in claim 8, wherein the first signal input terminal and the first signal output terminal are disposed on two sides of the first housing, respectively.

14. The Internet device as claimed in claim 8, wherein the second signal input terminal and the second signal output terminal are disposed on two sides of the second housing, respectively.

15. The Internet device as claimed in claim 8, wherein the circuit comprises a circuit board.

16. The Internet device as claimed in claim 8, wherein the signal connector receives an external Internet information.

17. The Internet device as claimed in claim 8, wherein the signal connector comprises an RJ-11, RJ-12 or RJ-45 connector.
